(19) United States
(12) Patent Application Publication
(10) Pub. No.: US 2022/0387153 A1
(43) Pub. Date: Dec. 8, 2022

(54) A Basic Device for Water Flossing

(71) Applicant: Tianhao Ding, (US)

(72) Inventor: Tianhao Ding, (US)

(21) Appl. No.: 17/342,516

(22) Filed: Jun. 8, 2021

(51) Int. Cl. A61C 15/04; A61C 17/032

(52) U.S. Cl. CPC A61C 15/047; A61C 17/032

(57) ABSTRACT

The subject invention comprises methods and an apparatus for making a non-electric dental water flosser. It connects a water flosser tip to a household faucet. The water flosser tip is an outlet for pressurized water to floss teeth. The flosser comprises only eight major parts: a water flosser tip (10), a quick connect fitting (20), a flexible plastic tubing (30), a faucet diverter valve (40), a faucet adapter (50), a supplement tubing (60), a water flosser tip rest holder (70), and an U-shaped shim (80).

The uniqueness of this flosser is its simplicity. All of its parts are commercially available in many hardware or online stores, and each part has many vendors. The parts are inexpensive, easy to assemble, easy to fix/replace, and it does not use electricity. For consumers, it costs less to own and to operate. If it breaks, there are multiple vendors for replacement parts.

### RELATED APPLICATIONS

This application claims the benefit under 35 USC 119(e) of U.S. Provisional Application No. 62/705,175, filed on Jun. 15, 2020, which is incorporated herein by reference in its entirety.

### BACKGROUND OF THE INVENTION

Traditional ways of dental floss use a thread to clean between the teeth. In recent years, water flossing has become more popular because it not only cleans teeth better, more importantly it doesn't require putting fingers inside the mouth which is critical to keep oral hygiene. Water flossing uses pressurized water to floss teeth. The pressurized water is either generated by an electric water pump or by water pressure from inside the faucet, Currently, all water flossing products on the market have many parts, many of which are specialized, which makes it complicated to manufacture and as a result costs more for both the manufacturer and the consumer. When it breaks, it is difficult to fix. All of these make them less environmentally friendly.

### SUMMARY OF THE INVENTION

The subject invention comprises methods and an apparatus for making a non-electric dental water flosser. It connects a water flosser tip to a household faucet. The water flosser tip is an outlet for pressurized water to floss teeth. The flosser comprises only eight major parts: a water flosser tip (10), a quick connect fitting (20), a flexible plastic tubing (30), a faucet diverter valve (40), a faucet adapter (50), a supplement tubing (60), a water flosser tip rest holder (70), and a shim (80).

The uniqueness of this flosser is its simplicity. All of its parts are commercially available in many hardware or online stores, and each part has many vendors. The parts are inexpensive, easy to assemble, easy to fix/replace, and it does not use electricity. For consumers, it costs less to own and to operate. If it breaks, there are multiple vendors for replacement parts.

### BRIEF DESCRIPTION OF DRAWING

In the accompanying drawings, reference characters refer to the same parts throughout the different views. The drawings are not necessarily to scale; emphasis has instead been placed upon illustrating the principles of the invention. Of the drawings:

FIG. 1 is an overall view of this invention. In its assembly (100), it consists of a water flosser tip (10), a quick connect fitting (20), a flexible plastic tubing (30), a faucet diverter valve (40), a faucet adapter (50), a supplement tubing (60), a water flosser tip rest holder (70), and a shim (80). On the faucet diverter valve (40), there is a tubing connector secured by a screw (41), a screw (42) to connect to the faucet adapter (50), and a handle (43).

FIG. 2 is a perspective view illustrating the water flosser tip (10) wherein it is in its rest position using a rest holder (70). The rest holder is also known as plastic tubing clamp; The perspective view also illustrates a supplement tubing (60) wherein it is inserted into the flexible tubing (30) as an enhancement and support.

FIG. 3 is a perspective view illustrating a shim (80) wherein it is used as a tool for disconnecting the water flosser tip (10) from the quick connect fitting (20).

FIG. 4 is a perspective view illustrating a quick connect fitting (20). The fitting has two identical collect openings (21): one for inserting the water flosser tip (10) and the other for the flexible tubing (30). On each collect (21), there is a release collar (23) and small teeth (22) that would press on the inserted object to make it difficult to slip out. The quick connect body (24) also serves as a handheld handle in this invention.

FIG. 5 is a perspective view illustrating a barbed connect fitting (50). The barbed connect fitting has barbs (51) at least on one end. The other end of it may be either another barbed connector or a quick connect fitting (52) as shown in the picture.

FIG. 6 is a perspective view illustrating a flosser tip rest holder (70), also known as plastic tubing clamp. As its name suggests, it is commonly used as a hose clamp as it was originally designed for. In this invention it is used as a flosser tip (10) rest holder.

FIG. 7 is a perspective view illustrating a shim (80) which has an U-shaped slot (81).

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein: rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Dental flossing has been proven to be important to maintain healthy teeth. Water flossing cleans teeth more thoroughly and cleanly, and more importantly there is no need to put one's fingers into their mouth. However, currently available water flossing dental devices have many parts, of which many of them, if not all, are specially manufactured. These specially made parts make them more costly to manufacture, and therefore more expensive for the consumers. When it breaks, it is expensive and difficult to repair or replace.

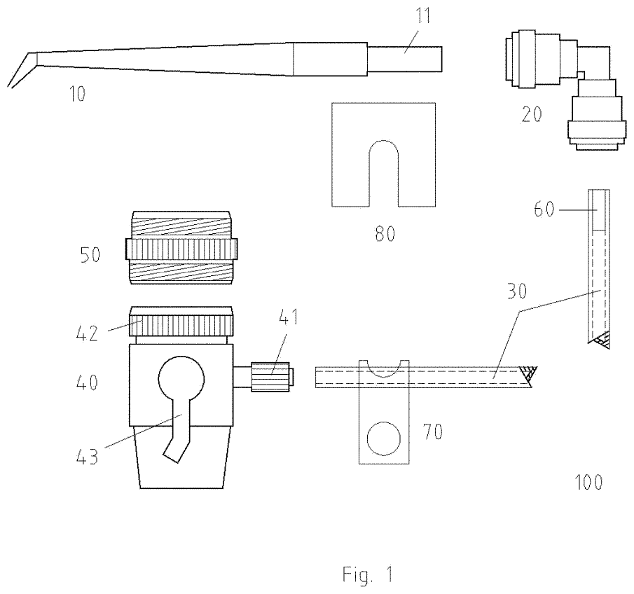

The current invention employs only eight major parts, FIG. 1, a water flosser tip (10), a quick connect fitting (20), a flexible plastic tubing (30), a faucet diverter valve (40), a faucet adapter (50), a supplement tubing (60), a water flosser tip rest holder (70), and a shim (80). The flosser is pre-assembled, and is ready for consumers to install and use. All parts are commercially available from many suppliers.

FIG. 1, shows the embodiment of a water fusser (100) according to the present invention. Here, the interconnections of all parts are described in more detail. The water flosser tip (10) is plugged into one end of the quick connect fitting (20). On the other end of the quick fitting (20), it is connected to the flexible plastic tubing (30). In this invention, the quick connect fitting (20) functions as a connector, at the same time as a handheld-handle. Inside the end of flexible tubing (30) where it is plugged into the fitting (20), there is a short supplement tubing (60). The supplement tubing (60) enhances the flexible tubing (30). The other end of the flexible tubing (30) is connected to the water diverter valve (40). The said connection is further secured by a screw (41). The water diverter valve then is connected to the faucet, adapter (50), and is secured by a screw (42). The faucet adapter (50) is, in turn, screwed on to a household faucet. The water diverter valve (40) has a handle (43) which is used to direct the water for either water flossing or normal use.

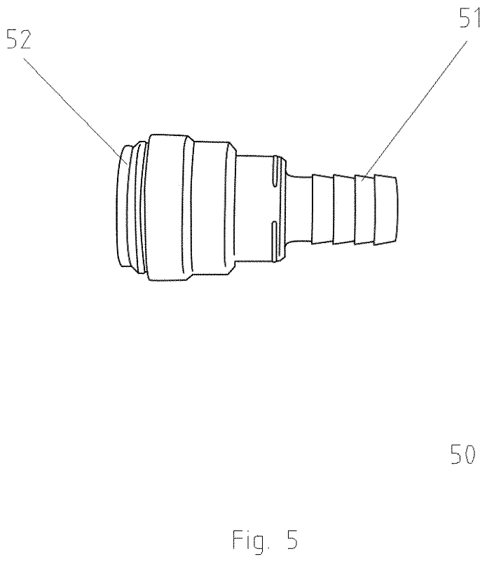

In this invention, the quick connect fitting (20) is used instead of a more common choice, a barbed connect fitting FIG. 5. Here, the reasons are explained for why a barbed connect fitting is not suitable in this invention. A barbed connect fitting is conventionally used to connect flexible/soft tubing. In practice, a barbed connector (51) is inserted into a flexible tubing. The barbs (51) work like teeth, which a tubing can hold onto to make it difficult to be pulled off the fitting, for example, under the water pressure. On average, faucet water pressure is 45-50 psi on the low side. In comparison, a car tire's air pressure averages around 32 psi. Because of the high water pressure, usually, a connection between a flexible tubing and a barbed connector is usually secured again by a screw, which means an additional part and more to be assembled. There are other disadvantages using a barbed connect fitting. For example, if a tubing is a little too soft, it can easily rupture as a result of water pressure; and if the tubing is too rigid, it can be difficult to insert the barbed connect fitting into it. In addition, when it comes time to replace the tubing, the barbed connect fitting is difficult to disconnect. That is why barbed connect fitting may be more conventional but not suitable for this invention.

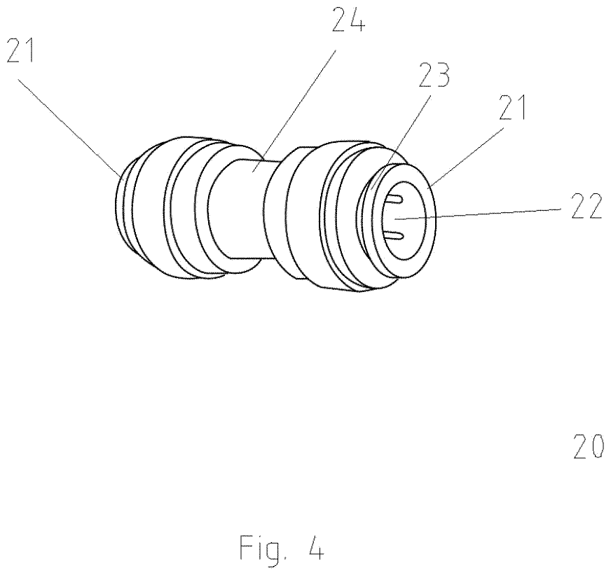

FIG. 4 shows a quick connect fitting (20). The use of the quick connect fitting in this invention is not without challenges. The quick connect fitting is usually used to connect two hard or semi rigid pipes and/or tubings. When the inserted object is not rigid enough such as flexible tubing, the seal between the tubing and the fitting cannot be made tight enough, which would lead to water leakage and tubing slipping out. In addition, the small teeth (22) on the collect (21) are designed to press on the inserted object, which could cause the flexible tubing slight disfigurement and result in water leakage. The teeth (22) are supposed to hold the tubing in place under pressure. However, due to the softness of flexible tubing, it cannot hold it tight enough, which, as a result, the tubing can slip out especially under pressures. The water leakage could be also caused by flexible tubing's permanent disfigurement because of material fatigue. These challenges make a flexible tubing unsuitable to connect to a quick connect fitting. For this invention, however, a flexible tubing is a must for the ease of use of the water flosser (100). To address the above mentioned challenges, a supplement tubing (60) is introduced.

The supplement tubing (60) is essential in this invention. It is inserted into the end of the flexible tubing (30) where it is plugged into the quick connect fitting (20). With the support of the supplement tubing (60), the flexible plastic tubing (30) won't leak and slip out easily because (a) the quick connect fitting's teeth (22) can hold on the flexible tubing (30) more tightly in place therefore a good seal can be kept between the tubbing (30) and the quick connect fitting (20), and (b) it won't easily deflate and expand unevenly. In addition, because of using the quick connect fitting, the flexible tubing can have a slightly thicker wall, which makes it more resistant to water pressure and makes it more durable. The material of supplement tubing could be either plastic or metal such as stainless steel. Its outside diameter should be the same as the inner diameter of the flexible plastic tubing (30). The supplement tubing has the same outside diameter from end to end, and its length has to be longer than the plugin length of the flexing tubing (30) inside the quick connect fitting. The supplement tubing (60) has to have adequate wall thickness to help the flexible tubing (30) withstand internal/external pressures, and/or material fatigue.

FIG. 4 shows a quick connect fitting (20) wherein its two identical collect openings (21) are in the same direction. There is another form of quick connect fitting (20) shown in FIG. 1 where the two collect openings (21) form a 90° degree angle. In this invention, either one of these two forms can be used. The quick connect fitting (20) has a body (24) FIG. 4 which is used as a handheld-handle.

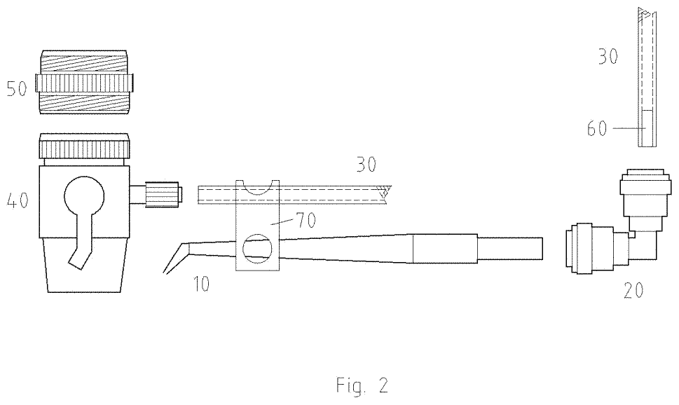

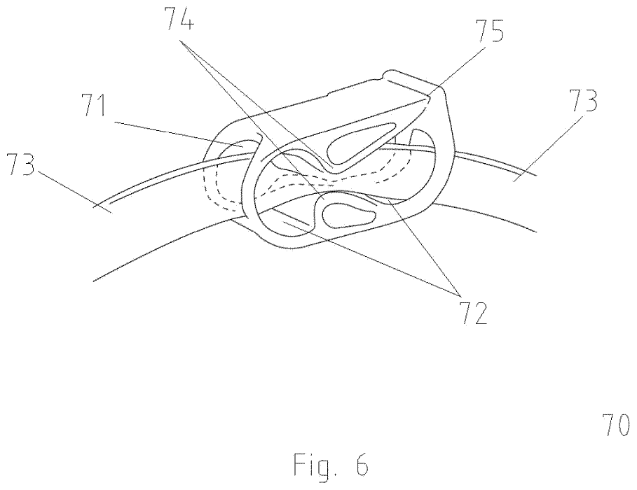

FIG. 2 shows the embodiment of the water flosser wherein a water flosser tip (10) is rested inside the rest holder (70), which is also known as plastic tubing clamp FIG. 6. Here, the conventional use of plastic tubing clamps is explained. A plastic tubing clamp (70) is a long plastic piece folded to form a clamp. Usually, a tubing (73) is placed inside the holes (71). When the clamps (74) are pressed together, it squeezes the tubing to stop the liquid within the tubing (73) from flowing. There is a mechanical lock (75) that locks the two ends of the plastic piece together. FIG. 6 shows the clamps in its locked position. This is the original intended application for the plastic tubing clamp (70).

In this invention, the plastic tubing clamp (70) has a new utility as a water flosser tip rest holder (70). As the clamp is self locked, it forms two holes (72), which are parallel to each other and perpendicular to the long side of the clamp (70). In this invention, the top hole (72) is used to hold on to the flexible tubing (30), and the bottom hole (72) is to hold the water flosser tip (10) when it is not in use. The rest holder (70) is placed close to a faucet so that the water flosser can be conveniently retrieved for flossing, and be restored after flossing. At the same, it is located inside and above the sink, so that drops of leftover water won't wet the counter. In addition, there is no need to stick anything on to the sink wall.

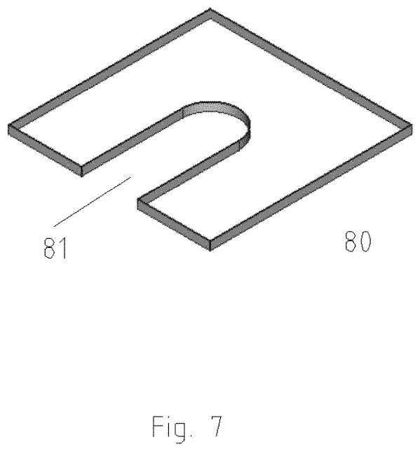

FIG. 7 shows a shim used in this invention. As defined in wikipedia.org, a shim is a thin and often tapered or wedged piece of material, used to fill small gaps or spaces between objects. Shims are typically used in order to support, adjust for better fit, or provide a level surface. Shims may also be used as spacers to fill gaps between parts subject to wear. In this invention, however, the shim (80) has a new utility.

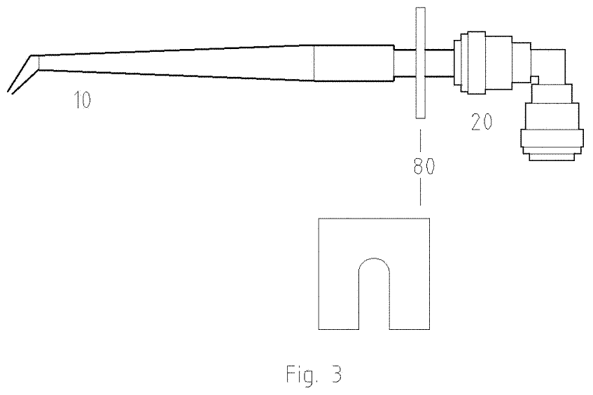

FIG. 3 shows the placement wherein the U-shaped shim (80) is placed on the water floss tip (10) and next to the quick connect fitting (20). This illustrates how to disconnect the water flosser tip (10) from the quick connect fitting (20). The quick connect fitting (20) has mechanical teeth (22), which would press and hold on the inserted object to prevent it from slipping out easily. To unplug it, one has to press the collect release collar (23) toward the quick connect fitting. Because the release collar (23) is tiny in size, it is difficult to press it effectively. With the help of the shim, a user can use the shim to easily push down the release collar (23), at the same time, pull the water floss tip (10) out of the quick connect fitting. The flexible tubing (30) can be unplugged from the quick connect fitting by repeating the above mentioned method.

The shim (80) is a useful tool for swapping water flosser tips (10), when, in a household, people share the same water flosser (100) and each person has their own personal water floss tip (10). When it comes time to replace the tip (10) or tubing (30), the shim is a handy tool too.

The shim (80) can be made of plastic or metal. The width of the U-shaped slot is equal to the diameter of the water flosser tip's plugin head (11).

As described above, the invention includes eight commercially available parts. Careful considerations are given to make it easy to assemble and disassemble. With the introduction of a supplement tubing inside the flexible tubing in conjunction with the quick connect fitting, the water flosser is connected conveniently and securely, and is durable.

What is claimed is:

1. A device for flossing teeth using pressurized water, the device comprising of:
a water flosser tip, a quick connect fitting, a flexible plastic tubing, a faucet diverter valve, a faucet adapter, a supplement tubing as an enhancement of the said flexible tubing, a water flosser tip rest holder, and a shim.
said water flosser tip can be unplugged from the said quick connect fitting when it needs to be swapped or replaced.
said flexible tubing can be unplugged when it needs to be swapped or replaced.
said flexible tubing has a supplement tubing which makes it more resistant to the internal/external pressures, and/or material fatigue.

2. The device as claimed in claim 1, wherein the quick connect fitting connects the water flosser tip and the flexible plastic tubing, and serves as a handheld-handle.

3. The device as claimed in, claim 1, wherein the supplement tubing is inserted into the flexible tubing as an enhancement, with that its outside diameter is equal to the inner diameter of the flexible tubing, that its wall thickness is chosen to be adequate to resist internal and external pressure on the flexible tubing, that its length is longer than the plugin length of the flexing tubing (30) inside the quick connect fitting, and that its material is either plastic or metal.

4. The device as claimed in claim 1, wherein the plastic tubing clamp is used as the water flosser tip rest holder, which is located near a faucet, and inside and above a sink, and is conveniently reachable.

5. The device as claimed in claim 1, wherein the shim is provided as a tool to help disconnect the water flosser tip or the flexible tubing from the quick connect fitting.

6. A method for flossing teeth using the pressurized water, the method comprising of:
using a quick connect fitting to connect a water flosser tip and flexible tubing; using a supplement tubing to enhance the flexible tubing; using a plastic tubing clamp as the water flosser tip rest holder; and using a shim as a tool to disconnect the water flosser tip or the flexible tubing from the quick connect fitting.

7. The method as claimed in claim 6 wherein a quick connect fitting is used to connect a water flosser tip and a flexible tubing, and is used as a handheld handle.

8. The method as claimed in claim 6 wherein the supplement tubing is inserted into the said flexible tubing, with that its outside diameter is equal to the inner diameter of the flexible tubing, that its wall thickness is chosen to be adequate to resist internal and/or external pressure on the said flexible tubing, that its length is longer than the plugin length of the said flexing tubing inside the quick connect fitting, and that its material is either plastic or metal.

9. The method as claimed in claim 6 wherein a plastic tubing clamp is used as the water flosser tip rest holder, which is placed close to the faucet for easy reach, and is located inside and above the sink for not wetting the counter.

10. The method as claimed in claim 6 wherein a shim is used to assist when disconnecting the water flosser tip or the flexible tubing from the quick connect fitting.
